(19) United States
(12) Patent Application Publication
(10) Pub. No.: US 2006/0289060 A1
(43) Pub. Date: Dec. 28, 2006

(54) Viscosity auto detector of paste maker

(76) Inventor: Chen-Hui Chen, Kao-Hsiung Hsien (CN)

Correspondence Address: Chen-Hui Chen, 235 Chung-Ho, Box 8-24, Taipei, TW

(21) Appl. No.: 11/158,202

(22) Filed: Jun. 22, 2005

(51) Int. Cl. F16K 17/36; G05D 11/00

(52) U.S. Cl. 137/38; 137/92

(57) ABSTRACT

A viscosity auto detector of a paste maker connected to a barrel of a paste maker; the viscosity auto detector comprises a flow detector; the flow detector being formed by a casing, a blade assembly and an encoder installed; an inlet being formed at one end of the casing; the inlet being connected to a bottom of the barrel of the paste maker through a conduit; another end of the casing being installed with an outlet; the outlet being connected to a tank for being stored therein temporarily. In the manufacturing process, when the glue flows through the casing, it will drive the blade assembly; the rotation of the blade assembly is encoded through the encoder into digital signals which is then transferred to a computer for counting; thereby the viscosity in the manufacturing process can be derived precisely; and thus the viscosity of the paste can be precisely controlled.

### FIELD OF THE INVENTION

The present invention relates to paste makers, and in particular to a viscosity auto detector of a paste maker, wherein a flow detector is provided to detect the viscosity of glue in the manufacturing process so that the operator can know the viscosity and then the viscosity of the glue is controlled in the manufacturing process.

### BACKGROUND OF THE INVENTION

The glue made of natural starch is used greatly in industrial application, for example, the glue used in the manufacturing process of corrugated papers. The prior art paste maker will be described in the following.

As shown in FIG. 1, a double barrel paste maker (for example Stein Hall type paste maker) includes a first barrel 10 and a second barrel 20. In the manufacturing process, 150 kg of water is filled into the first barrel 10 and then 12 kg of starch is filled into the first barrel 10 to be agitated uniformly in the water. Then 7 grams of alkali water is added. The mixing solution is heated by vapor and is agitated uniformly through a time period of about 15 minutes so as to have glue like material which is called as a carrier. Furthermore, 340 kg of water and 20 kg of borax are filled into the second barrel 20. After the borax is solved into the water, 138 kg of starch is added thereto so that the starch is sufficiently floated in the water. Then, the carrier in the first barrel 10 is filled into the second barrel 20 and then they are agitated sufficiently to have a desired viscosity. Finally 7 kg of agent (for example resin) is added therein so as to complete the process.

In another singe barrel paste maker (no-carrier paste make, as shown in FIG. 2). A barrel 30 is filled with 450 kg of water under a temperature about 36° C. and then 4.2 kg of caustic sodium is added thereinto about 3 minutes. Then, 150 kg of starch is added to the solution through about 3 minutes to be agitated therein. Then 150 kg of starch is added and is agitated uniformly about 5 minutes. Then caustic sodium is added for dilute the solution and then the solution is agitated sufficiently to have a desired viscosity. Then boric acid and agent (such as resin) are added thereinto.

However in above mentioned two process, the viscosity is determined by the quality of the agent. Thereby in the manufacturing process, it must check the viscosity of the starch continuously. Currently, it is performed by manually taking a measuring cup which is determined by eyes and experience. Time and labor are consumed uneconomically. Furthermore, the quality cannot be well controlled due the carelessness of the operator. Moreover the natural starch is not so uniformly due to the object used and whether and places of the growth of the starch and types of the starch so that the starch is not so uniformly and thus it is difficult to control the viscosity manually.

### SUMMARY OF THE INVENTION

Accordingly, the primary object of the present invention is to provide a viscosity auto detector of a paste maker, wherein a flow detector is provided to detect the viscosity in the manufacturing process so that the operator can know the viscosity and then the viscosity is controlled in the manufacturing process.

A viscosity auto detector of a paste maker connected to a barrel of a paste maker; the viscosity auto detector comprises a flow detector; the flow detector being formed by a casing, a blade assembly and an encoder installed; an inlet being formed at one end of the casing; the inlet being connected to a bottom of the barrel of the paste maker through a conduit; another end of the casing being installed with an outlet; the outlet being connected to a tank for being stored therein temporarily. In the manufacturing process, when the glue flows through the casing, it will drive the blade assembly; the rotation of the blade assembly is encoded through the encoder into digital signals which is then transferred to a computer for counting; thereby the viscosity in the manufacturing process can be derived precisely; and thus the viscosity of the paste can be precisely controlled.

The various objects and advantages of the present invention will be more readily understood from the following detailed description when read in conjunction with the appended drawing.

### BRIEF DESCRIPTION OF THE DRAWINGS

FIG. 1 is a schematic view about a prior art double-barrel paste maker.

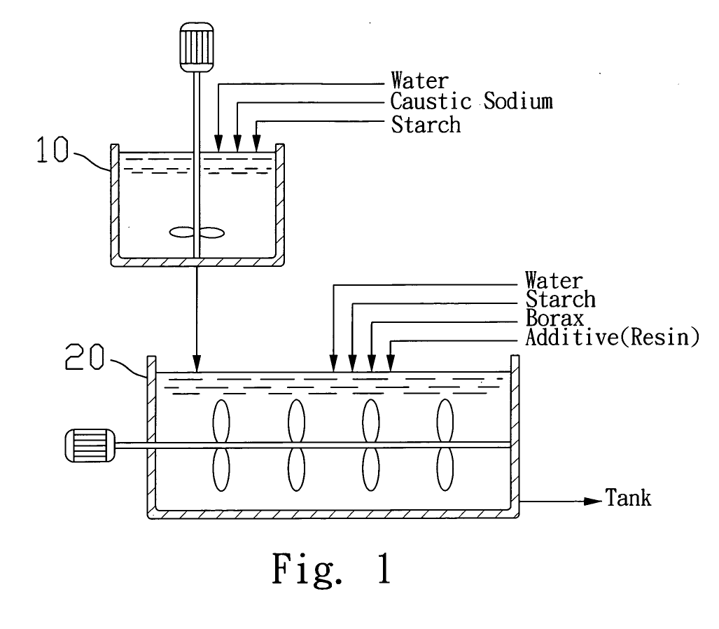

FIG. 2 is a schematic view about a prior art single barrel paste maker.

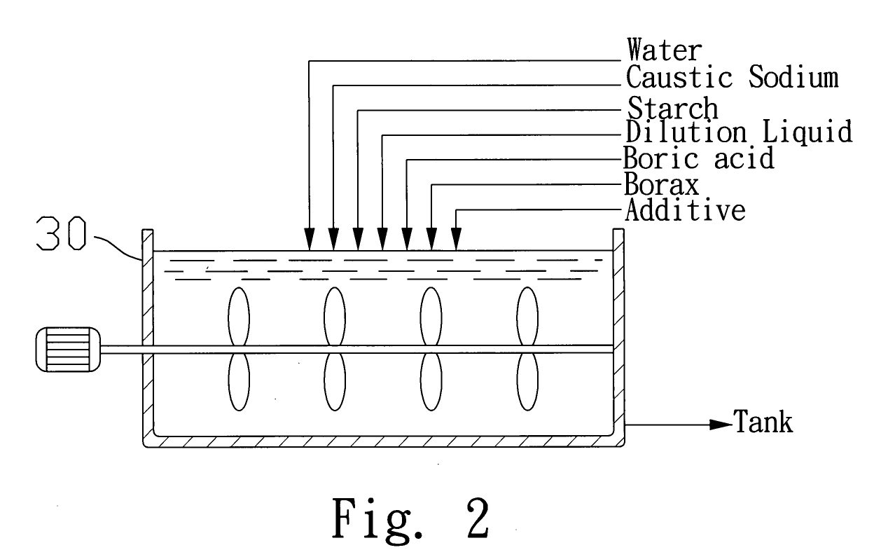

FIG. 3 is a schematic view showing that the present invention is used to a double-barrel paste maker.

FIG. 4 is a schematic view showing that the present invention is used to a single barrel paste maker.

FIG. 5 is a perspective view about the flow detector of the present invention.

FIG. 6 is a cross sectional view of the flow detector of the present invention.

### BRIEF DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

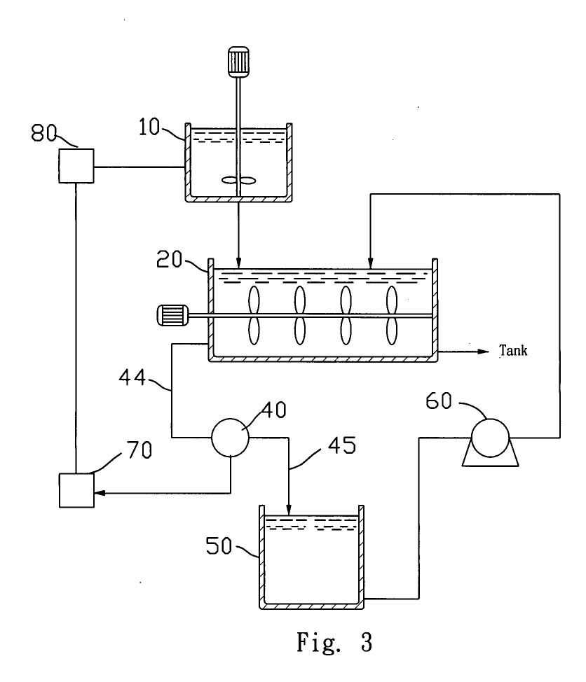

Referring to FIGS. 3 to 6, the structure double-barrel paste maker of the present invention is illustrated.

With reference to FIG. 3, a first embodiment of the present invention is illustrated. The double-barrel paste maker according to this embodiment has the following elements. The double-barrel paste maker has a first barrel 10 and a second barrel 20. A viscosity auto detector is installed at a bottom of the barrel.

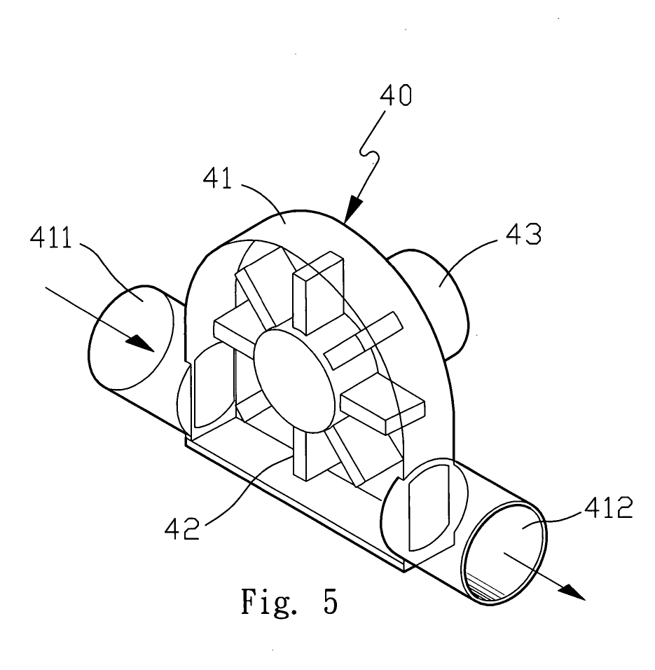

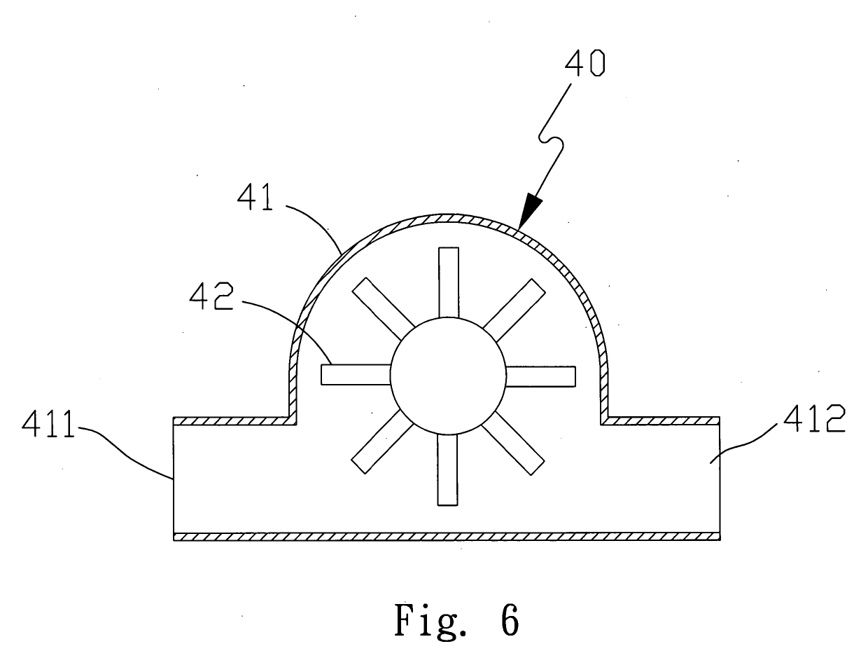

With reference to FIGS. 5 and 6, the viscosity auto detector includes a flow detector 40. The flow detector 40 is formed by a casing 41, a blade assembly 42 in the casing 41 and an encoder 43 installed at an outside of the casing 41. An inlet 411 is formed at one end of the casing 41. The inlet 411 is connected to a bottom of the second barrel 20 through a conduit 44 (see FIG. 3). Another end of the casing 41 is installed with an outlet 412. The outlet 412 is connected to a tank 50 for being stored therein temporarily.

In FIG. 3, it is illustrated that the glue in the tank 50 can be transferred to the second barrel 20 through a pump 60.

In the manufacturing process, the glue in the second barrel 20 flows along the conduit 44 to enter into the casing 41. Then the glue flows out of the casing 41 through the outlet 412 and then flows into the tank 50 through the conduit 45. When the glue flows through the casing 41, it will drive the blade assembly 42. The viscosity of the glue is inversely proportional to flow (amount or speed) of the glue, that is, the lower the viscosity, the greater the flow (amount or speed) and thus the blade assembly 42 rotates rapidly, and vice versa. The rotation of the blade assembly 42 is encoded through the encoder 43 into digital signals which is then transferred to a controller 70 for counting the viscosity and generating control signals which will be transferred the viscous adjusting unit 80 which receives the control signals so as to adjust the viscosity of the glue, for example, adjust the amount additives such as resin. In this embodiment, the viscosity adjusting unit 80 is connected to the first barrel 10. Thereby the viscosity in the manufacturing process can be derived precisely. Thus the viscosity of the paste can be precisely controlled to have steady viscosity. Moreover the glue in the tank is transferred to a barrel through a pump.

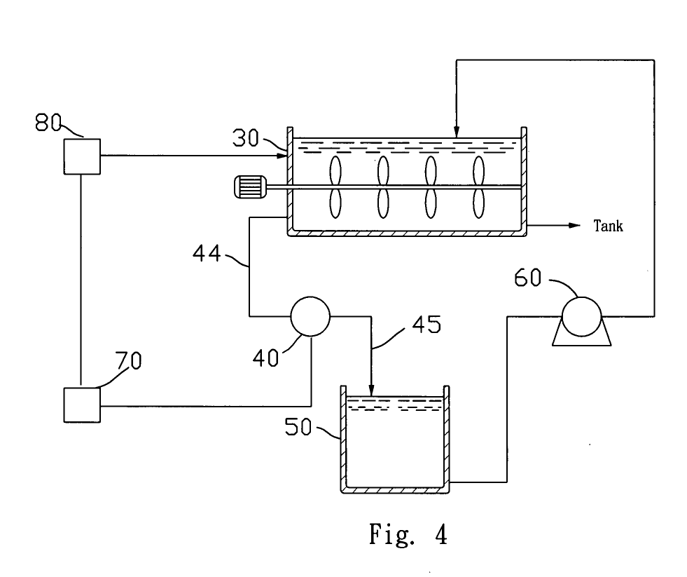

Referring to FIG. 4, the second embodiment of the present invention is illustrated, where the present invention is used to a single barrel paste maker. The structure has only one barrel 30. The viscosity auto detector is connected to the bottom of the barrel 30. In FIG. 4, it is illustrated that the glue in the tank 50 can be transferred to the second barrel 30 through a pump 60. In this embodiment, the viscosity adjusting unit 80 is connected to the barrel 30. The structure and function of the viscosity auto detector is identical to those disclosed in the first embodiment, and thus the detail will not described herein.

Thereby from above described, it is known that by the present invention, the viscosity of the glue can be known in the manufacturing process so as to control the viscosity of glue to be more uniform.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A viscosity auto detecting system of a paste maker connected to a barrel of a paste maker; the viscosity auto detector system comprising
a flow detector; the flow detector being formed by
a casing,
a blade assembly in the casing and
an inlet being formed at one end of the casing; the inlet being connected to a bottom of the barrel of the paste maker through a conduit; and
an outlet at another end of the casing; and the outlet being connected to a tank for being stored therein temporarily;
an encoder installed at an outside of the casing for transferring signals about the rotation of the blade assembly into digital signals;
a controller for counting the viscosity and generating control signals; and
a viscous adjusting unit for receiving the control signals from the controller so as to adjust the viscosity of the glue; and
wherein in the manufacturing process, the glue in the barrel of the paste maker flows along the conduit to enter into the casing; then the glue flows out of the casing through the outlet and then flows into the tank through the conduit; when the glue flows through the casing, it will drive the blade assembly; the viscosity of the glue is inversely proportional to flow amount or flow speed of the glue; the rotation of the blade assembly is encoded through the encoder into digital signals which is then transferred to the controller for determining the viscosity of the glue; thereby the viscosity in the manufacturing process can be derived precisely; and thus the viscosity of the paste can be precisely controlled to have steady viscosity.

2. The viscosity auto detector of a paste maker as claimed in claim 1, wherein paste maker is a double-barrel paste maker.

3. The viscosity auto detector of a paste maker as claimed in claim 1, wherein paste maker is a single barrel paste maker.

4. The viscosity auto detector of a paste maker as claimed in claim 1, wherein the glue in the tank is transferred to a barrel through a pump.
